(19) United States
(12) Patent Application Publication
(10) Pub. No.: US 2024/0172879 A1
(43) Pub. Date: May 30, 2024

(54) STIR STICK DISPENSER FOR A BEVERAGE VENDING MACHINE

(71) Applicant: Evoca S.P.A., Valbrembo (IT)

(72) Inventor: Dan Alexie SIRBU VILLA, Valbrembo (IT)

(21) Appl. No.: 18/551,687

(22) PCT Filed: Mar. 25, 2022
(86) PCT No.: PCT/IB2022/052761

§ 371 Date: Sep. 21, 2023

(30) Foreign Application Priority Data
Mar. 25, 2021 (IT) 102021000007343

(51) Int. Cl. A47F 1/10

(52) U.S. Cl. CPC A47F 1/10; A47F 2001/103

(57) ABSTRACT

A stir stick dispenser, comprising a stir stick magazine that contains a stack of stir sticks on a support surface, and an extractor arranged below the magazine to extract stir sticks therefrom. The magazine comprises a counteracting member partially defining an outlet of the magazine having a height of the same thickness of a stir stick to allow one to pass through the outlet. Only a central portion of the stir stick at the bottom of the stack rests on the support surface and the side portions of the stir stick protrude from the support surface. The member has a width equal to the support surface, and the lower end of the magazine is spaced from the support surface greater than the height of the outlet, such that during extraction, the member and the lower end do not interfere with the side portions, even when they are downwardly or upwardly curved.

### CROSS-REFERENCE TO RELATED APPLICATIONS

This patent application claims priority from Italian Patent Application No 102021000007343 filed on Mar. 25, 2021, the entire disclosure of which is incorporated herein by reference.

### TECHNICAL FIELD OF THE INVENTION

The present invention relates to a stir stick dispenser for a beverage vending machine.

### STATE OF THE ART

In the vending field it is known to arrange inside a beverage vending machine a stir stick dispenser controlled by an electronic control unit of the beverage vending machine in order to dispense a stir stick directly in a cup delivered in a cup filling station to receive the beverage. The stir stick is normally released in the cup before the cup is filled with the beverage, and it can be dispensed only if sugar is required in the selected beverage.

In general, a known stir stick dispenser comprises a stir stick magazine containing one or more columns of orderly stacked stir sticks, and an extractor operated, in use, to move reciprocally and transversally with respect to the stir sticks, through a lower outlet of the stir stick magazine to eject, by a back-and-forth movement through the lower outlet, only the stir stick at the bottom of the stack and to let it fall directly in the cup or on a slide driving it to the cup.

Stir stick dispensers of the kind specified above are known, for example, from EP 1 586 254 A1, EP 2 345 010 A1, EP 2 563 187 A1, and EP 1 107 200 A2.

Stir stick dispensers of the kind specified above have been used for decades in a fairly satisfying way in order to dispense plastic stir sticks, but revealed serious drawbacks as long as plastics was outlawed after recent regulations concerning environment protection came into force, and the operators of this field were obliged to adopt alternative “green” solutions, particularly to use stir sticks made of biodegradable or compostable materials such as wood or paper.

The problems connected with the use of wood or paper stir sticks inside conventional dispensers originate from the fact that, in these dispensers, the extractor, the stir stick magazine and the stack of stir sticks are configured to interact with each other with high precision so that the movement of the extractor allows the extraction of a single stick from the bottom of the stack.

As for plastics stir sticks, such a precision is normally assured over time by the fact that the shape and size of the stir sticks stacked in the stir stick magazine remain substantially stable, regardless of the environmental conditions inside the automatic dispenser.

On the contrary, the same precision cannot be assured in case of stir sticks made of other materials than plastics, particularly wood and paper, since, as known, these materials suffer a lot from temperature and humidity changes, and it can occur that the stir sticks deform to a point that the action of the extractor is ineffective, thus causing the stir stick dispenser to jam.

### OBJECT AND SUMMARY OF THE INVENTION

The object of the invention is to provide a stir stick dispenser for a beverage vending machine that allows the above-described drawbacks to be overcome.

This object is achieved by a stir stick dispenser for a beverage vending machine, as claimed in the appended claims.

### BRIEF DESCRIPTION OF THE DRAWINGS

The present invention will now be described with reference to the accompanying drawings, illustrating a non-limiting implementation example, wherein:

FIG. 1 illustrates, in a perspective view and with parts removed for clarity, a preferred embodiment of the stir stick dispenser according to the invention;

FIG. 2 illustrates, in a front view, a detail of the stir stick dispenser of FIG. 1;

FIGS. 3 and 4 are similar to FIG. 2 and illustrate the stir stick dispenser in the case in which the stick arranged at the bottom the stick stack is deformed; and

FIGS. 5 and 6 illustrate, in a cross-section and enlarged view, the stir stick dispenser of FIG. 1 in a rest position and in an extraction position of a stir stick, respectively.

### DETAILED DESCRIPTION OF PREFERRED EMBODIMENTS OF THE INVENTION

The present invention will now be described in detail with reference to the appended figures to allow a person skilled in the art to produce and use the same. Various modifications to the described embodiments will become immediately apparent to those skilled in the art and the described general principles can be applied to other embodiments and applications without departing from the protective scope of the present invention, as defined in the appended claims. Therefore, the present invention should not be considered limited to the described and illustrated embodiments, but it is intended to have the widest protective scope in accordance with the described and claimed characteristics.

Unless otherwise defined, all technical and scientific terms used herein have the same meaning commonly used by those of ordinary skill in the art of the present invention. In case of a dispute, the present description, comprising the definitions provided, will be binding. Furthermore, the examples are provided only for illustrative purposes and as such they should not be regarded as limiting.

In order to facilitate the understanding of the embodiments herein described, reference will be made to some specific embodiments and specific language will be used to describe them. The terminology used in this document is intended to describe only particular embodiments and is not intended to limit the scope of the present invention.

In the appended Figures, reference numeral 1 indicates as a whole a stir stick dispenser of the kind normally contained inside a beverage vending machine (not illustrated) operable to automatically supply a stir stick 2 in a cup to be filled with a beverage.

The stir sticks 2 of the example described in the present description and shown in the appended figures are in the form of elongated flat elements, each having a longitudinal axis A and comprising two rounded end portions and an intermediate portion delimited by two larger flat faces and two straight and thin flanks. Although this is the most adopted shape for stir sticks, that in this shape are also usually referred to as stirrers, however, the stir stick dispenser of the present invention is also configured to dispense stir sticks having proportions or a shape that are different from the ones of stir sticks of the illustrated example. For example, the stir sticks can have a circular cross-section or similar.

The stir stick dispenser 1 is designed to dispense stir sticks 2 of any kind, but it is particularly adapted when the stir sticks 2 to be dispensed are made of a material, for example wood or paper, that could cause, after a period and/or in certain environmental conditions, the onset of deformity, in particular a longitudinal warping, in the stir stick 2.

The stir stick dispenser 1 comprises a stir stick magazine 3 disposed to contain a stack 4 of stir sticks 2 orderly stacked, and an extractor 5 arranged under the stir stick magazine 3 and having an upper support surface 6, on which, when the extractor 5 is in a rest position, the stack 4 of stir sticks 2 in the stir stick magazine 3 rests.

Furthermore, the extractor 5 comprises a pusher 7, which is mounted to move back and forth, with respect to the stir stick magazine 3, so as to laterally engage the stir stick 2 resting on the support surface 6 in order to push it transversally through an outlet 8 of the stir stick magazine 3 until the stir stick 2 is completely extracted from the stack 4 and free to fall downwards.

In a preferred embodiment illustrated in the accompanying figures, the support surface 6 and the pusher 7 are integral and are both formed on the extractor 5 that is, in this case, in the form of a swivelling member hinged to pivot about a fixed axis 9 parallel to the longitudinal axis A of the stir sticks 2 in the stir stick magazine 3.

In particular, the swivelling member 5 comprises an arm 10 directly hinged to pivot about the axis 9 and a head portion 11 connected to a free end of the arm 10.

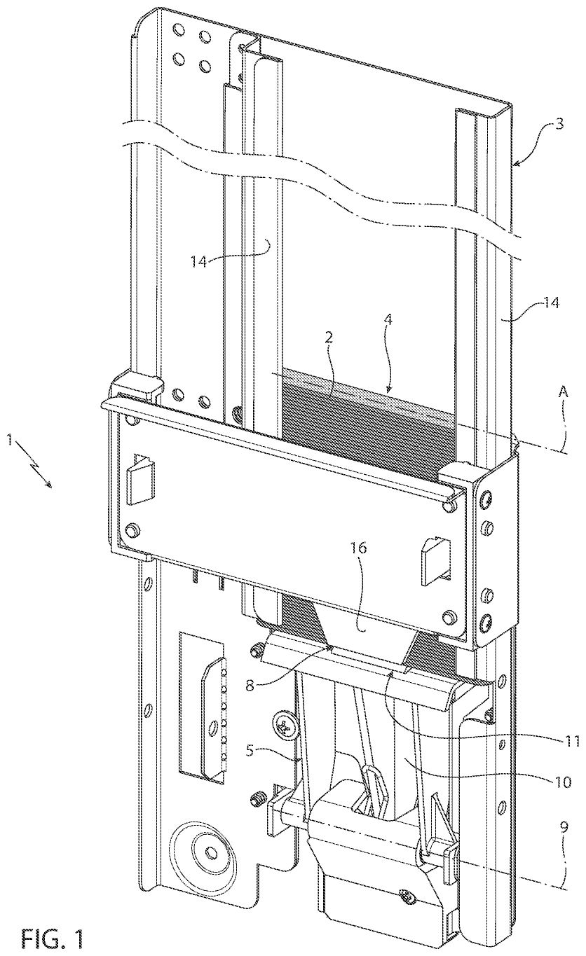

In particular, as shown in FIGS. 1, 5 and 6, the head portion 11 comprises a lowered or support portion 12, whose upper surface forms said support surface 6, and a raised portion 13, which is arranged, in the rest position of the extractor 5, on the opposite side of the stir stick magazine 3 with respect to the outlet 8. The lowered portion 12 and the raised portion 13 are connected to each other by a step, which extends parallel to the axis 9 and to the longitudinal axis A of stir sticks 2, and has a height that is lower than, or at most equal to, the thickness of a stir stick 2.

The step between the lowered portion 12 and the raised portion 13 forms said pusher 7 adapted to eject the stir stick 2 at the bottom of the stack 4 in response to the oscillation of the swivelling member 5 about the axis 9.

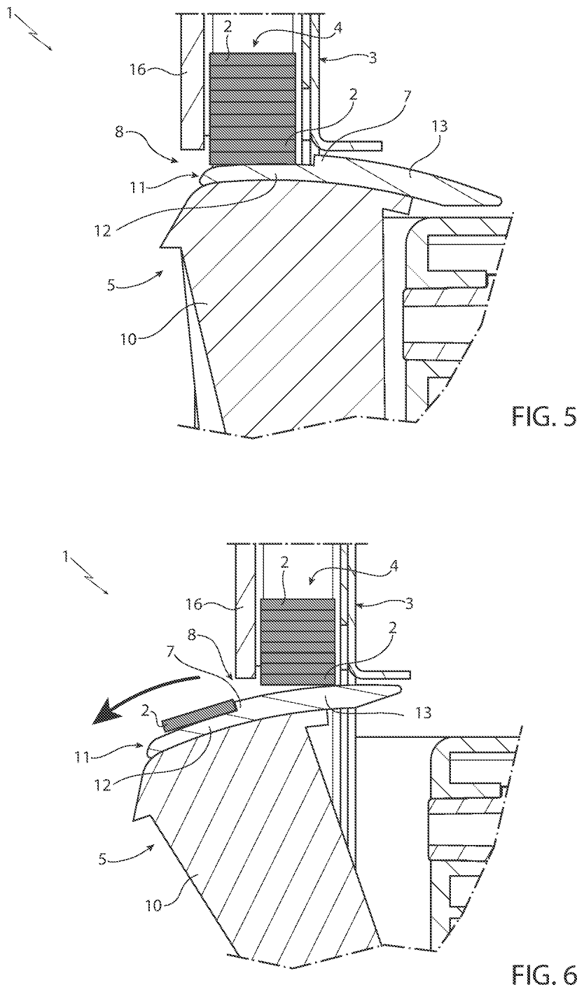

For this purpose, the beverage vending machine comprises an electric actuator (not illustrated) which is connected, preferably through a cam transmission (not illustrated), to the swivelling member 5 and electronically controlled by an electronic unit of the beverage vending machine and configured to cause the swivelling member 5 to move between said rest position (FIG. 5), in which the stir sticks 2 rest on the support surface 6, and the step, i.e., the pusher 7, is facing the stir stick 2 at the bottom of the stack 4, and an extraction position (FIG. 6), in which the swivelling member 5 is rotated forwards so that the pusher 7 is arranged beyond the outlet 8 of the stir stick magazine 3. While moving between the rest position and the extraction position, the pusher 7 engages a flank of the stir stick 2 resting on the support surface 6 and pushes it in a direction transversal to the longitudinal axis A through the outlet 8 of the stir stick magazine 3 until the stir stick 2 is ejected from the stack 4. When the extraction position is reached, the swivelling member 5 returns to the rest position, preferably under the force of a spring.

During the extraction of a stir stick 2, the stack 4 is supported by the raised portion 13 of the extractor 5 and returns resting on the lowered portion 12 when the swivelling member 5 returns to the rest position.

Thus, in the embodiment described above, the extractor 5 comprises a lowered portion 12 and a raised portion 13 that move integrally as parts of an oscillation member.

In a different embodiment (not illustrated), the lowered portion 12 is stationary, whereas the raised portion 13 is movable and is part of an oscillating member, as in the previous case. The stationary lowered portion 12 and the movable raised portion 13 are configured so as to allow the raised portion 13 to move with respect to the lowered portion 12 during the movement from the rest position to the extraction position, and vice versa. Preferably, the lowered portion 12 and the raised portion 13 are shaped such that they intersect in a comb-like way during the movement of the raised portion 13.

In a variation of this embodiment, the raised portion 13 does not oscillate but it is configured to have a reciprocating translational movement.

In an alternative embodiment (not illustrated), when the extractor 5 is in the rest position, the stack 4 rests on the upper surface of the raised portion 13 instead of the lowered portion 12, and the extractor 5 is controlled to eject a stir stick 2 at the bottom of the stack 4 during the return stroke instead of during the forward stroke of the extractor 5. Also in this embodiment, the lowered portion 12 can be integral to the raised portion 13, thus movable with it, or stationary. When the raised portion 13 moves from the rest position, where it supports the stack 4, the latter falls resting on the lowered portion 12, so when the raised portion 13 returns to the resting position, the pusher 7 causes the stir stick 2 resting on the lowered portion 12 to be extracted and the stack 4 returns resting on the raised portion 13. Also in this embodiment, the raised portion 13 can be actuated in order to make an oscillation or translational movement.

Regardless of the configuration of the extractor 5, the support surface 6 is so sized as to engage only a central portion of the stir stick 2 arranged at the bottom of the stack 4, i.e., the width of the support portion 6, measured in the direction parallel to the longitudinal axis A of the stir sticks 2, is such that it such that the stir stick 2 at the bottom of the stack 4 is in contact with the support surface 6 only at a central portion 2a of the stir stick 2 and not all along the length thereof. The remaining part of the stir stick 2 is made of two side portions 2b arranged on opposite sides of the central portion 2a such that it is not in contact with the support surface 6.

Preferably, said central portion 2a has a predetermined length as a function of the deformation which is typical of the kind of stir sticks 2 that are loaded in the stir stick magazine 3.

The pusher 7 can have the same width of the support surface 6, measured in parallel to the longitudinal axis A of the stir sticks 2, or it can have a predetermined width as a function of the deformation typical of the kind of stir sticks 2 that are loaded in the stir stick magazine 3, for example greater than that of the support surface 6, in particular a width which is equal to or smaller than the length of the stir sticks 2.

In the preferred embodiment illustrated in the appended figures, the stir stick magazine 3 comprises a casing defining an inner cavity so sized as to precisely contain the stack 4 and having a substantially horizontal transversal axis parallel to the longitudinal axes A of the stir sticks 2 and a substantially vertical longitudinal axis.

The casing can have any shapes provided that it is adapted to laterally guide the stack 4 so as to keep it orderly when it goes down along the casing by the progressive extraction of the stir sticks 2 from the bottom of the stack 4. A weight (not illustrated) is normally arranged on the top of the stack 4, which serves to keep the stack 4 firm as stir sticks 2 are extracted and go down along the inner cavity.

In the embodiment illustrated in the appended figures, the casing comprises two U-shaped shoulders 14, which are arranged around the ends of the stir sticks 2, and a rear plate connecting the two shoulders to each other and extending along a side of the stack 4 opposite the outlet 8.

Preferably, one of the two shoulders 14 is movable in order to be able to move closer or back from the other shoulder 14 to adapt the size of the casing to the length of the stir sticks 2.

The casing has a lower edge or lower end 15, which is spaced apart from the support surface 6, in a direction perpendicular to said support surface 6, greater than the thickness of a stir stick 2, preferably a distance of at least twice the thickness of a stir stick 2.

Finally, the stir stick magazine 3 comprises a counteracting member 16, which is arranged, with respect to the casing, on the same side of the outlet 8, and serves to avoid, when the stir stick 2 at the bottom of the stack 4 is pushed out of the stack 4 by the pusher 7, other stir sticks 2 to be dragged through the outlet 8.

For this purpose, the counteracting member 16 extends in front of at least the lower portion of the stack 4, and has a lower edge 17 which is parallel to the longitudinal axis A of the stir sticks 2 and facing the support surface 6, at a predetermined distance from the latter, as a function of the thickness of the stir sticks 2, in particular of one and a half times the thickness of a stir stick 2, so as to define, with said support surface 6, the above mentioned outlet 8 of the stir stick magazine 3. The counteracting member 16 can be mounted to the casing of the stir stick magazine 3 or be integrated in the casing.

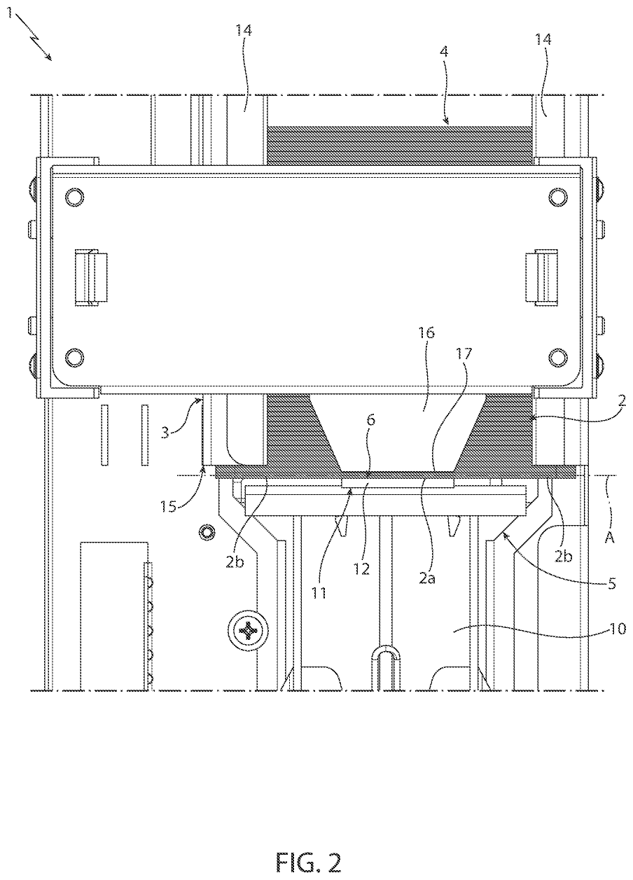

As shown in FIGS. 2 to 4, the counteracting member 16 has a width, at least close to its lower edge 17, substantially of the same width as the support surface 6 so as to face the stack 4, at least close to the lower edge 17, only at a central portion of the stir sticks 2 lying on the stir stick 2 resting on the support surface 6.

The fact that the counteracting member 16 is sized to laterally engage the stack 4 only at a central portion of the stir stick 2 and that the support surface 6 is sized to engage the stir stick 2 at the bottom of the stack 4 only at the central portion 2a of the stir stick 2, along with the fact that the lower end 15 of the stir stick magazine 3 is arranged at a distance from the support surface 6 which is greater than the thickness of a stir stick 2, result in the extractor 5 being always able to extract the bottom stir stick 2 even when the latter is deformed, in particular it has lost its flatness, for example because of humidity absorbed by the stir stick 2 inside the beverage vending machine.

In fact, the size of the support surface 6, the size of the counteracting member 16 and the distance of the lower end 15 of the stir stick magazine 3 from the support surface 6 are chosen, with respect to the length and the thickness of the stir sticks 2, so as the side portions 2b of the stir stick 2 protrude cantilevered from the support surface 6 and are not constrained either at the bottom by the support surface 6, or at the top by the counteracting member 16 or by the lower end 15 of the stir stick magazine 3 and thus can freely deform upwards or downwards without affecting the flatness of the central portion 2a of the stir stick 2 and its stable contact with the support surface 6.

Furthermore, the size of the support surface 6, the size of the counteracting member 16 and the distance of the lower end 15 of the stir stick magazine 3 from the support surface 6 are chosen, in addition to the length and the thickness of the stir sticks 2 to be dispensed, also as a function of the material of the stir sticks 2 that contributes, together with other features of the stir sticks 2, including length and thickness, to determine the deformity the stir sticks 2 are subjected to, when they stay for a relatively long period in the environment where the stir stick dispenser 1 operates.

The deformity of the stir sticks 2 is typically represented by an upward or downward warping, with respect to the surface on which the stir stick 2 rests, determining an increase of the overall transversal footprint of the stir stick 2 to a predetermined maximum transversal footprint.

The maximum deformity, thus the resultant maximum transversal footprint, which the stir sticks 2 are subjected to, is experimentally determined by a static characterisation procedure allowing the deformation features of the stir stick 2 to be determined in different temperature and humidity conditions which are characteristic of environments where the stir sticks 2 can possibly be located.

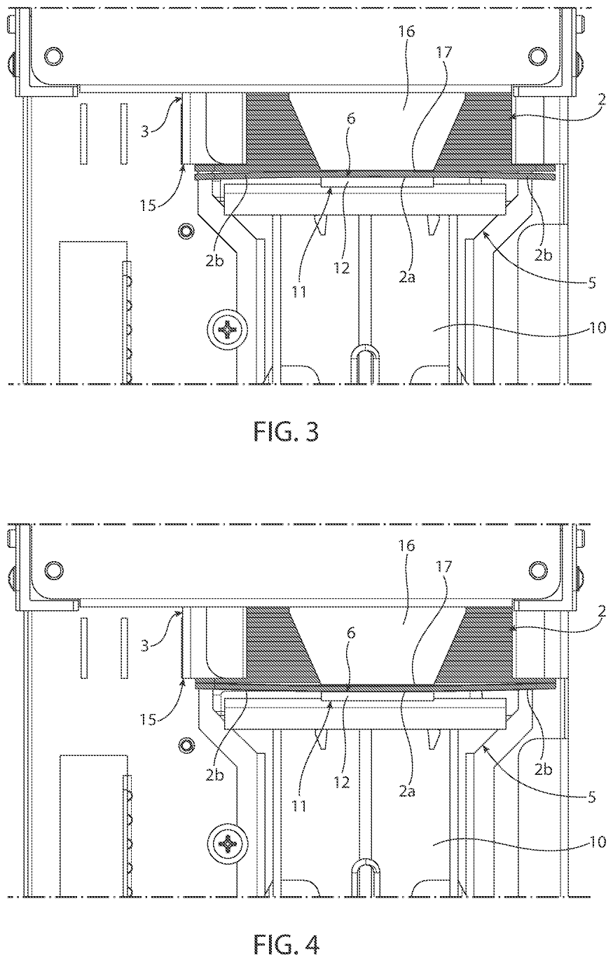

FIG. 3 represents the case in which the deformed stir stick 2 is longitudinally curved, forming a downward recess, i.e., towards the extractor 5. If the side portions 2b of the stir stick 2 were resting on the support surface 6, as in known stir stick dispensers, such a deformation would determine the lifting from the support surface 6 of the central portion 2a, which, under the action of the pusher 7 during extraction, would interfere with the counteracting member 16, and possibly with the lower end 15 of the stir stick magazine 3, avoiding the stir stick 2 to pass through the outlet 8 and causing the stir stick dispenser 1 to jam.

Since in the stir stick dispenser 1 of the present invention the side portions 2b of the stir stick 2 do not rest on the support surface 6 and are free to bend downwards, the central portion 2a remains resting on the support surface 6 and aligned with the outlet 8, resulting in the stir stick 2 to be correctly extracted from the stack 4.

Instead, FIG. 4 represents the case in which the deformed stir stick 2 is longitudinally curved, forming an upward recess, i.e., towards the counteracting member 16. If the lower end 15 of the stir stick magazine 3 was at a distance from the support surface 6 equal to the thickness of the stir stick 2, and if the counteracting member 16 had a width such as to also extend in front of the side portions 2b of the stir stick 2, as in known stir stick dispensers, such a deformation would determine the lift from the support surface 6 of the side portions 2b, which, under the force of the pusher 7 during extraction, would interfere with the lower end 15 of the stir stick magazine 3 and possibly with the counteracting member 16, avoiding the stir stick 2 to pass through the outlet 8 and causing the stir stick dispenser 1 to jam.

Since in the stir stick dispenser 1 of the present invention the lower end 15 of the stir stick magazine 3 is sized to stay at a certain determined distance from the support surface 6 and the counteracting member 16 is sized to extend only in front of a central portion of the stack 4, the lift of the side portions 2b caused by the deformation does not involve any interferences either with the lower end 15 of the stir stick magazine 3 or with the counteracting member 16, resulting in the fact that the stir stick 2 can be correctly extracted from the stack 4.

In the illustrated example, the arm 10 of the swivelling member 5 is wider than the head portion 11, but the upper portion of the arm 10 is anyway sized so as to not interfere with the side portions 2b of the stir stick 2 arranged resting on the support surface 6 if the stir stick 2 were deformed and the side portions 2b were bent downward.

In a different embodiment, the upper part of the arm 10 does not protrude laterally beyond the head portion 11 and, preferably, the arm 10 and the head portion 11 are obtained from a single piece.

1-10. (canceled)

11. A stir stick dispenser for a beverage vending machine, the stir stick dispenser comprising:
a stir stick magazine configured to contain a stack of stir sticks arranged to rest on a support surface; wherein each stir stick of the stack of stir sticks can be affected by an upward or downward warping, with respect to the support surface, resulting in an increase of an overall transversal footprint of the stir stick up to a predetermined maximum transversal footprint; and
an extractor arranged below the stir stick magazine to extract individual stir sticks from the stack;
wherein the extractor is operable to move transversally to a longitudinal axis of the stir sticks from and to a rest position, in which the stack is arranged to rest on the support surface, and to extract, at every back-and-forth movement, the stir stick arranged on the bottom of the stack;
wherein the stir stick magazine includes a counteracting member, a lower edge of which defines, together with the support surface, an outlet of the stir stick magazine having a height of the same thickness of a stir stick to allow a single stir stick to pass through the outlet at every extraction;
wherein the support surface is so sized that only a central portion of the stir stick at the bottom of the stack is resting on the support surface, while leaving side portions of the stir stick protruding cantileverly from the support surface;
wherein the counteracting member has a width, at least at a lower edge thereof, substantially equal to the width of the support surface, and the stir stick magazine comprises a lower end spaced apart from the support surface, in a direction orthogonal to the longitudinal axes of the stir sticks, by a distance greater than a height of the outlet of an extent that, during extraction of a stir stick, the counteracting member and the lower end of the stir stick magazine do not interfere with the side portions of the stir stick, even when the stir stick resting on the support surface, is affected by such a warping as to result in an increase of the overall transversal footprint of the stir stick within the predetermined maximum transversal footprint.

12. The stir stick dispenser of claim 11, wherein the extractor comprises a raised portion that is arranged at a higher level than the support surface and which, in the rest position of the extractor, is arranged on the opposite side of the stir stick magazine with respect to the outlet thereof; the raised portion defining, with the support surface, a step defining a pusher designed to transversally push the stir stick arranged at the bottom of the stack through the outlet.

13. The stir stick dispenser of claim 12, wherein the raised portion is configured so that, during extraction of a stir stick, the stack remains resting on the raised portion and returns resting on the support surface when the extractor returns to the rest position.

14. The stir stick dispenser of claim 12, wherein the extractor is mounted to oscillate around a fixed axis parallel to the longitudinal axes of the stir sticks.

15. The stir stick dispenser of claim 12, wherein the extractor is mounted to reciprocate along an axis transversal to the longitudinal axes of the stir sticks.

16. The stir stick dispenser of claim 14, wherein the support surface is either movable integrally with the raised portion or is stationary.

17. The stir stick dispenser of claim 11, wherein the support surface has a width, measured parallel to the longitudinal axis of the stir sticks, which is a function of the deformation to which the stir sticks can be subjected.

18. The stir stick dispenser of claim 11, wherein the counteracting member, at least close to the lower edge thereof, extends in front of the stack only at a central portion of the stack, namely a central portion of the stir sticks lying on the stir stick resting on the support surface.

19. The stir stick dispenser of claim 11, wherein the stir stick magazine comprises a casing defining an inner cavity so sized as to contain the stack and having a substantially horizontal transversal axis parallel to the longitudinal axes of the stir sticks and a substantially vertical longitudinal axis; the casing has a lower edge facing the support surface and defining said lower end of the stir stick magazine.

20. A beverage vending machine comprising a stir stick dispenser according to claim 10.
